(19) United States
(12) Patent Application Publication
(10) Pub. No.: US 2026/0108992 A1
(43) Pub. Date: Apr. 23, 2026

(54) METHOD OF ENHANCING SURFACE PROPERTIES OF MOLDS AND TOOLS USING ADDITIVE MANUFACTURING

(71) Applicant: Thermwood Corporation, Dale, IN (US)

(72) Inventor: Kenneth J. SUSNJARA, Birdseye, IN (US)

(73) Assignee: Thermwood Corporation, Dale, IN (US)

(21) Appl. No.: 18/920,476

(22) Filed: Oct. 18, 2024

(51) Int. Cl. B23P 21/00

(52) U.S. Cl. CPC B23P 21/004

(57) ABSTRACT

A method for producing an object involves receiving a three-dimensional computer-aided design (3D CAD) model of the object, slicing the 3D CAD model into a plurality of layers, cutting a plurality of layer segments from non-porous material, assembling the plurality of layer segments into the plurality of layers and fastening the plurality of layers together to form a blank, machining the blank to a final shape, and applying a coating to an outer surface of the machined blank using a thermal spray process to form an outer surface of the object.

### TECHNICAL FIELD

Aspects of the present disclosure relate to apparatus and methods for fabricating components. Some aspects of the present disclosure relate to methods and systems for fabricating components (e.g., patterns, molds, similar products, or other parts) via techniques or processes that have similarities with 3D printing manufacturing processes involving layering or 3D printing manufacturing, itself. These techniques or processes may enable, in at least some embodiments, production of lower-cost molds or tooling with or without the use of a 3D printer.

### BACKGROUND

Additive manufacturing techniques and processes generally involve the buildup of one or more materials to make a net or near net shape (NNS) object, in contrast to subtractive manufacturing methods. Although “additive manufacturing” is an industry standard term (ASTM F2792), additive manufacturing encompasses various manufacturing and prototyping techniques known under a variety of names, including freeform fabrication, 3D printing, rapid prototyping/tooling, etc.

Some additive manufacturing techniques use large-scale 3D printers that are capable of fabricating very large parts, molds, patterns, etc. These parts can be produced from fiber-reinforced thermoplastic materials for example. One method of producing these parts utilizes a polymer extruder which generates a bead of molten thermoplastic material which is added to the part being produced one layer at a time. These layers can be modified and/or flattened into wider beads during the additive manufacturing process using devices such as tamping plates, rollers, or the like. Using these approaches, sometimes referred to as 3D printing, the part is made slightly larger than desired. After the part cools and hardens, it is then machined to the final size and shape. The resulting part is generally a shell of a specific thickness and of the approximate size and shape desired.

Another type of additive manufacturing can be referred to as “cut layer” additive manufacturing. In some examples of cut layer additive manufacturing, pieces can be cut from porous material, stacked on top of one another, and attached together to create a part. In some cases, this part may be hollow, comprised of individual parts that are narrow beads that, when stacked together, create a shell or wall around the outside shape of the desired part. In some approaches, a shell or wall is built from a porous material and infused with a catalyzed thermoset liquid. The liquid cures to produce a rigid composite part reinforced with the porous material.

There are times, however, when it is desirable to produce a part from non-porous material such as metal (e.g., aluminum). Again, the non-porous material is stacked on top of one another and attached together to create a part. This part may be hollow, comprised of individual parts that are narrow beads that, when stacked together, create a shell or wall around the outside shape of the desired part.

Industrial molds and tooling made using the cut layer additive process can be made from metal, such as aluminum. These can be used in a number of different polymer processes such as thermoforming of thermoplastic sheet material, blow molding, rotational molding, reaction injection molding, high pressure injection molding, compression molding and similar. They can also be used for other industrial tooling fixturing applications.

In at least some applications, these additively-manufactured molds and tools, made using the above process, replace tooling produced using conventional, non-additive, manufacturing processes, which are typically more expensive and involve longer fabrication time than additive manufacturing methods.

In at least some cases, tooling is produced using material that can not be processed using either of the additive manufacturing processes described above. In these instances, use of this mold and tooling material can result in products (e.g., molds and tools) that possesses working surfaces that have advantages in comparison with materials that are typically used in additively-manufactured molds and tools. These advantages include, among others, wear resistance, toughness, chemical resistance and desirable mold release properties. Generally, these desirable properties are characteristic of the material used to make the molds or tools. While having benefits, these materials are both expensive and difficult to processes, resulting in molds and tools that possess the desirable surface properties, but that are relatively high in cost and that involve relatively long lead times to fabricate.

Some processes that utilize large molds have additional requirements such as those used in the manufacture of composite aerospace parts in a heated autoclave. These processes can require a completely sealed outer mold working surface capable of sustaining a vacuum seal for an extended period of time. At least some additive manufacturing processes are not capable of producing such totally sealed working surfaces.

### SUMMARY

Aspects of the present disclosure relate to, among other things, methods and apparatus for fabricating components via layering techniques. Each of the aspects disclosed herein may include one or more of the features described in connection with any of the other disclosed aspects. invention first aspects of the disclosure is a method to produce lower cost molds and tools, in less time, using the additive manufacturing process of cut layer manufacturing, that also have the desirable working surfaces of molds and tools performed by other methods, or that have surfaces with additional or different advantages.

One aspects of the disclosure involves applying a permanent thin outer coating, comprised of a desirable material, onto the surface of an additively-manufactured mold or tool. It would be desirable to apply this surface using one of a wide variety of material, including various metals such as, among others, alloys, tungsten carbide, chrome carbide, stainless steel, Hastelloy, zinc, aluminum, tin, copper, nickel, cobalt, and Inconel. Other surface material may also be desirable, such as, among others, abradables, cermets, ceramics, and various polymers.

The applied surface could be either the same material used in higher-cost molds or tools produced by other methods, or potentially an even more desirable material, from which a desired mold or tool can not easily be fabricated by other methods, resulting in a superior working surface.

One way of applying this desirable coating to a variety of base material, such as a base material used to produce additively manufactured molds and tooling, is to utilize a process referred to herein as Thermal spray. Thermal spray, which can also be referred to as metalizing, is a process of melting powder or wire in a gas stream and applying the semi-molten material to a substrate.

In some aspects, the techniques described herein relate to a method of producing an object, the method including: receiving a three-dimensional computer-aided design (3D CAD) model of the object; slicing the 3D CAD model into a plurality of layers; cutting a plurality of layer segments from non-porous material, wherein each of the plurality of layer segments corresponds to at least a portion of one of the plurality of layers; assembling the plurality of layer segments into the plurality of layers and fastening the plurality of layers together to form a blank; machining the blank to a final shape; and applying a coating to an outer surface of the machined blank using a thermal spray process to form an outer surface of the object.

In some aspects, the techniques described herein relate to a method of producing an object, the method including: receiving an article including a plurality of layer segments that are assembled and secured together, each of the plurality of layer segments having been cut from non-porous material and corresponding to at least a portion of a layer of a three-dimensional computer-aided design (3D CAD) model of the object; machining the article to a final shape using a computer numerical control (CNC) machine; and applying a coating to an outer surface of the machined article using a thermal spray process, wherein the thermal spray process is performed via a CNC machine having a gantry.

In some aspects, the techniques described herein relate to a method of producing an object, the method including: receiving a three-dimensional computer-aided design (3D CAD) model of the object; slicing the 3D CAD model into a plurality of layers; cutting a plurality of layer segments from non-porous material, wherein each of the plurality of layer segments corresponds to at least a portion of one of the plurality of layers; assembling the plurality of layer segments into the plurality of layers and fastening the plurality of layers together to form a blank; machining the blank to a final shape; preparing an outer surface of the machined blank for coating application using a surface preparation process; and applying a coating to the prepared outer surface of the machined blank using a thermal spray process to form an outer surface of the object, wherein the surface preparation process and the thermal spray process are performed by an integrated system including a gantry-style CNC machine configured with at least one of: (i) a dual-head configuration including a surface preparation head and a thermal spray coating head, or (ii) an exchangeable head system allowing for switching between a surface preparation head and a thermal spray coating head.

In some aspects, the techniques described herein relate to a method of producing an object, the method including: generating a three-dimensional computer-aided design (3D CAD) model of the object; slicing the 3D CAD model into a plurality of layers; cutting a plurality of layer segments from non-porous material, wherein each of the plurality of layer segments corresponds to a portion of one of the plurality of layers; assembling the plurality of layer segments into a plurality of layers and fastening the plurality of layers together to form an object blank; machining the object blank to a final shape; and applying a coating to an outer surface of the machined object blank using a thermal spray process. In some aspects, the techniques described herein related to wherein the non-porous material is selected from the group consisting of aluminum, steel, and titanium. In some aspects, the techniques described herein related to wherein the coating comprises a material selected from the group consisting of alloys, tungsten carbide, chrome carbide, stainless steel, hastelloy, zinc, aluminum, tin, copper, nickel, cobalt, inconel, abradables, cermets, ceramics, and polymers. In some aspects, the techniques described herein related to wherein the outer surface is a continuous, cohesive surface.

### BRIEF DESCRIPTION OF THE DRAWINGS

The accompanying drawings, which are incorporated in and constitute a part of this specification, illustrate exemplary aspects of the present disclosure and together with the description, serve to explain the principles of the disclosure.

FIG. 1 is a perspective view of an exemplary CNC routing machine with controller operable pursuant to routing out layers of sheet material, according to an aspect of the present disclosure.

FIG. 2A is a perspective view of an exemplary part made up from multiple layers cut out of a sheet of material and assembled together.

FIG. 2B is a top view of the exemplary part of FIG. 2A.

FIG. 3A is a perspective view of an exemplary part machined to the proper final size and shape.

FIG. 3B is a perspective view of the exemplary part of FIG. 3A.

FIG. 4 is a perspective view of the part undergoing the thermal spray process.

FIG. 5 is a perspective view of the gantry style CNC machine performing the thermal spray operation.

FIG. 6A is a perspective view of the final part with a surface coating.

FIG. 6B is a perspective view of the final part of FIG. 6A.

FIG. 7 is a flow chart of the steps in the process of producing a cut layer mold/tooling with a surface coating.

### DETAILED DESCRIPTION

The present disclosure is drawn to, among other things, methods and apparatus for fabricating multiple components via layering techniques. Specifically, the methods and apparatus described herein comprise a method to produce lower cost molds and tools, in less time, using the additive manufacturing processes that also have the same or better working surfaces than the conventionally produced molds and tools.

In some embodiments, the term “part” may refer to a component configured to serve as a mold or tooling element in a production process. This part is utilized in one or more steps to aid in the manufacturing of various objects for industries including automotive, aerospace, consumer products, medical devices, or the like. The part may be constructed from various materials and configured with specific features to meet particular production needs, thereby ensuring its applicability in multiple manufacturing techniques and processes.

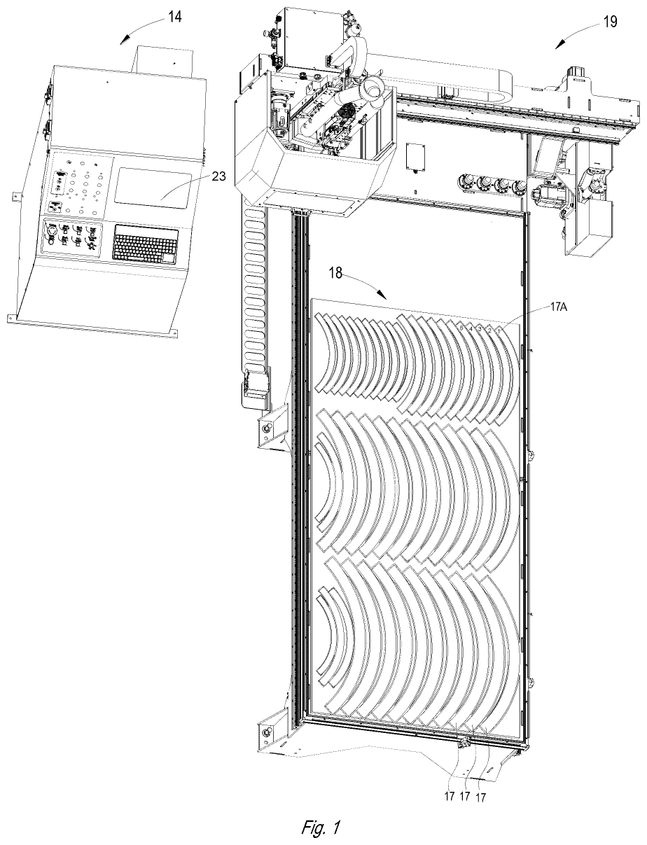

Referring to FIG. 1, in some embodiments, a computer numerical control (CNC) routing machine 19 is operably connected to a controller 14 configured to direct the operation of the routing machine 19. The controller 14 is further connected to a display 23, which is configured to provide a visual interface for monitoring and controlling the routing process.

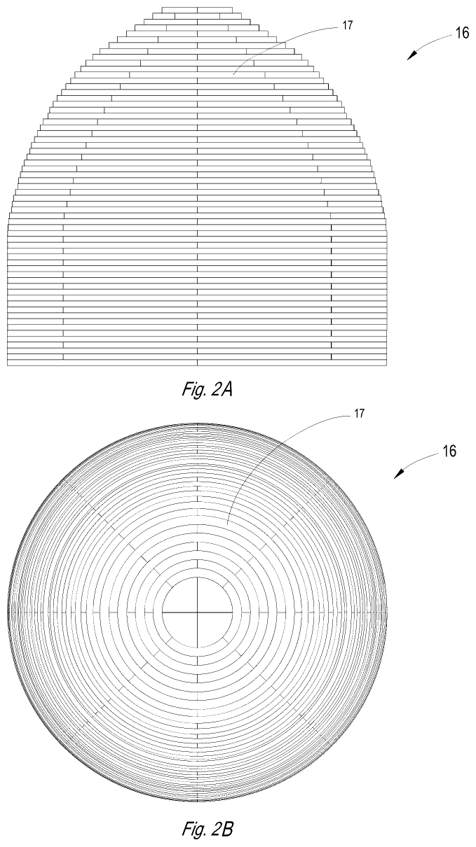

In some embodiments, the CNC routing machine 19 is operably connected to controller 14 and is configured to perform at least one or more steps of a cut layer additive manufacturing process. Generally, a blank 16 (shown in FIGS. 2A and 2B) is assembled by stacking parts and/or layers 17, which are cut from sheets of material 18. Material 18, in some embodiments, is a porous material, such as medium-density fiberboard (MDF), while in some embodiments material 18 is a solid material, such as aluminum. Layers 17, which may be produced from one or more cuts by the routing machine 19, may be of a pre-determined size, which may range from relatively narrow strips that are less than an inch (approximately 2.54 centimeters) wide to wider strips which are more than an inch wide, such as being two inches (approximately 5.08 centimeters) wide. Once formed, the layers are manually or automatically (e.g., with a CNC machine or industrial robot controller by controller 14 or with another control system) stacked and secured to one another, forming a blank 16. The blank 16 is sized to approximately correspond to a desired size and shape of an object, such as a part in the form of a mold or a tool. The process, in some embodiments, produces a part that is similar in structure to parts produced by being 3D printed or otherwise formed by additive manufacturing. For example, the part is constructed of stacked layers 17.

In some embodiments, the routing machine 19 is configured to receive a sheet of material 18, which may comprise a variety of suitable substrates, such as wood, metal, plastic, composite materials, or the like. The sheet material 18 is securely positioned on the bed of the routing machine 19, enabling cutting operations to be performed.

In some embodiments, the controller 14 is configured to receive computer-aided design (CAD) data representing a three-dimensional model of an object to be manufactured. The controller 14 processes the CAD data and generates machine-readable instructions that define the cutting paths and parameters required to produce a plurality of cut layer segments 17 from the sheet material 18. These instructions are transmitted to the routing machine 19, which executes the cutting operations accordingly.

In some embodiments, the display 23 is configured to present a graphical user interface (GUI) that allows an operator to input, modify, and monitor various parameters of the routing process. The GUI may display information such as the CAD model, cutting progress, machine status, and alerts or warnings related to the operation of the routing machine 19. The display 23 provides a means for the operator to interact with the controller 14 and make any necessary adjustments to optimize the cutting process.

In some embodiments, as the routing machine 19 executes the cutting instructions received from the controller 14, machine 19 progressively cuts the sheet material 18 into a plurality of cut layer segments 17. These segments 17 correspond to cross-sectional layers of the three-dimensional object being manufactured. The cut layer segments 17 may be arranged in a specific order and orientation on the bed of the routing machine 19, facilitating their subsequent assembly into the final object.

Referring to FIGS. 2A and 2B, in some embodiments, aspects of the disclosure include assembling the cut layer segments 17 produced by the routing machine 19 into a three-dimensional object. The cut layer segments 17 are stacked and aligned according to the CAD model to form a layered part blank 16, which approximates the desired shape of the final object. In some embodiments, the cut layer segments 17 are marked or labeled with identifying information, such as the layer number or assembly order, to facilitate accurate stacking and alignment during the assembly process. This marking may be performed by the routing machine 19 as part of the cutting process or may be done manually by an operator.

In some embodiments, the assembly process involves applying an adhesive or bonding agent between each layer of cut layer segments 17 to ensure a strong, stable bond between the layers. The adhesive may be a specialized compound that is compatible with the non-porous material of segments 17 and to provide adherence and durability.

In some embodiments, the assembled part blank 16 may undergo a curing or hardening process to further strengthen the bonds between the cut layer segments 17. This process may involve subjecting the blank 16 to heat, pressure, or a combination of both, in one or more ordered combination and/or multiple steps of one or more ordered combinations, depending on the specific adhesive or bonding agent used.

In some embodiments, the part blank 16 may be subjected to additional machining or finishing processes to refine its shape and dimensions. These processes may include sanding, grinding, or CNC machining to remove any irregularities or excess material, ensuring that the blank 16 accurately represents the desired geometry of the final object.

In some embodiments, the assembled part blank 16 serves as a precursor to the final mold or tool. The blank 16 may be used directly in the production process, such as in thermoforming or composite layup applications. Alternatively, the blank 16 may undergo further processing, such as the application of a surface coating or the creation of a negative mold, to produce the final mold or tool.

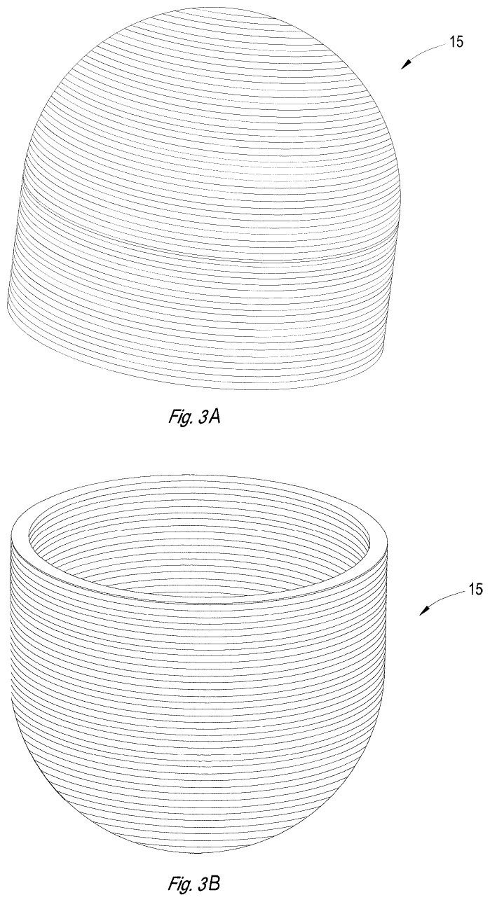

Referring to FIG. 3A and FIG. 3B, in some embodiments, the part blank 16 undergoes a machining process to achieve its final desired shape and dimensions, resulting in the machined part 15. The machining process is performed using a computer numerical control (CNC) machining center, which in some embodiments may be a machine separate from routing machine 19, which is configured to remove excess material from the part blank 16 based on the CAD model of the final object.

In some embodiments, the CNC machining center is equipped with a variety of cutting tools, such as end mills, ball nose mills, drills, and the like, which are selectively employed to machine the part blank 16. The choice of cutting tool depends on the specific geometry and features of the final part 15, as well as the material properties of the blank 16.

In some embodiments, the machining process involves a series of roughing and finishing passes to gradually remove material and refine the shape of the part 15. The roughing passes are configured to remove large amounts of material quickly, while the finishing passes are configured to achieve the desired surface finish and dimensional accuracy.

In some embodiments, the CNC machining center is programmed or otherwise configured with machining parameters, such as cutting speeds, feed rates, and depths of cut, which are optimized for the specific material and geometry of the part blank 16. These parameters are determined based on factors such as the hardness and machinability of the material, the size and complexity of the part 15, and the desired surface finish.

In some embodiments, the machining process may include the creation of complex features, such as contours, cavities, and protrusions, on the surface of the part 15. These features may facilitate functioning of the part 15 in its intended application, such as forming or shaping other materials.

In some embodiments, the CNC machining center is equipped with precision measurement devices, such as touch probes or laser scanners, which are configured to verify the dimensions and geometry of the machined part 15. These devices enable in-process inspection and quality control, ensuring that the final part 15 meets specifications.

In some embodiments, the machined part 15 may undergo additional post-processing steps, such as polishing, coating, or heat treatment, to further enhance its surface properties or durability. These post-processing steps are selected based on the specific requirements of the intended application and the desired performance characteristics of the part 15.

In some processes, the resulting part 15 would include a substrate with surfaces which may not include all possible benefits. It would therefore be advantageous to further modify the working surfaces to enhance these surfaces, allowing the surfaces to match or exceed the surfaces of molding and tooling production performed with other processes. In some embodiments, it may be advantageous to apply a permanent thin outer coating, comprised of a desirable material, onto the surface of an additively-manufactured part 15. In some embodiments, the surface comprises one or more materials, including, but not limited to, alloys, tungsten carbide, chrome carbide, stainless steel, Hastelloy, zinc, aluminum, tin, copper, nickel, cobalt, and Inconel. In some embodiments, additional surface material may also be desirable, such as, but not exclusive to abradables, cermets, ceramics, and the like. Advantageously, the resulting surface could have similar and/or improved properties when compared to other mold and/or tool manufacturing methods.

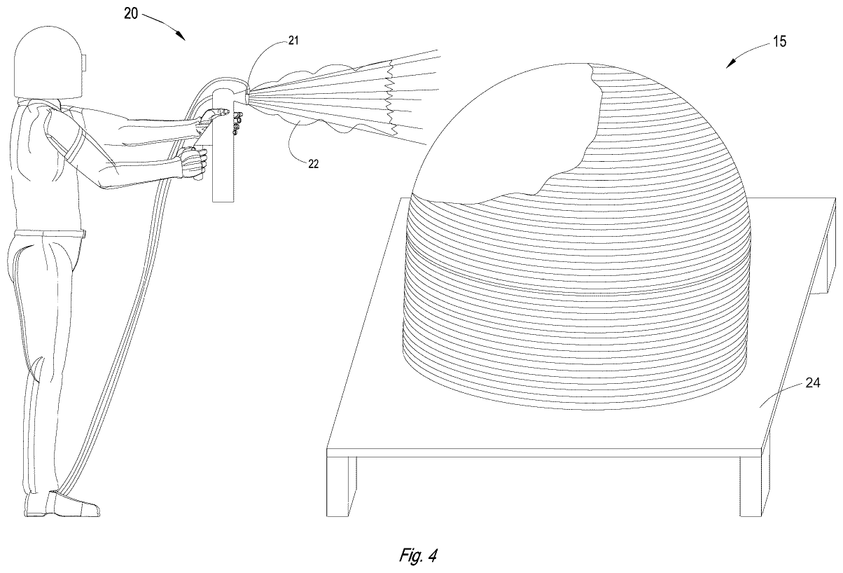

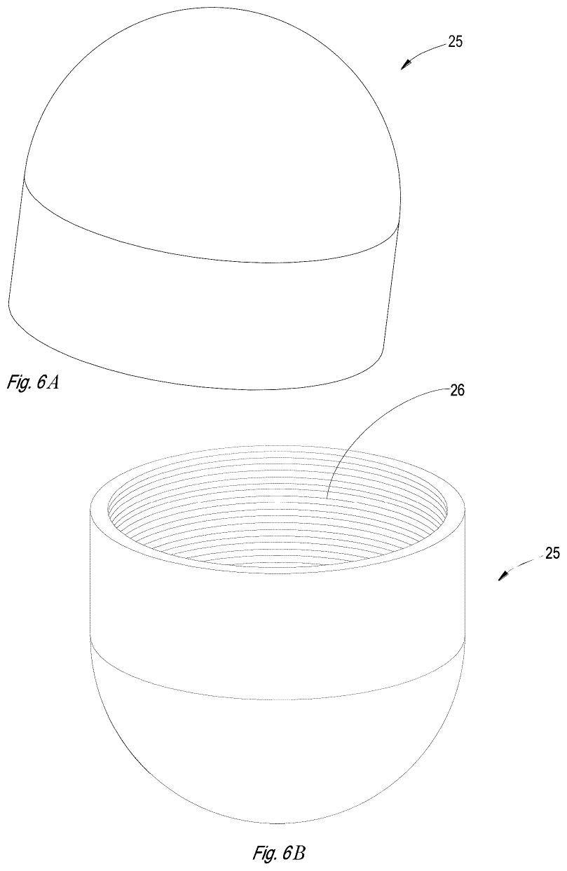

Referring to FIG. 4, in some embodiments, the machined part 15 undergoes a thermal spray coating process performed with a thermal spray coating system 20 to apply a layer of material onto its surface. The thermal spray process performed with thermal spray coating system 20 involves melting a powder, wire, and/or other material 21 in a high-temperature gas stream 22 and propelling the molten and/or semi-molten particles onto the surface of the part 15. In some embodiments, the thermal spray coating system 20 may be configured to perform High Velocity Air Fuel (HVAF) Spray, High Velocity Oxygen Fuel (HVOF) Spray, Spray and Fuse, Plasma Spray, Arc Spray, Flame Spray, and the like. Due to the wide variety of materials which this process may utilize, there is a wider selection of potential resulting surfaces when compared to other mold and/or tool manufacturing methods. Additionally, the resultant surface is cohesive, such that the final enhanced working surface is more resilient, resistant, and provides no evidence of layer joints from the manufacturing process, such that the resultant surface can sustain a desired level of vacuum integrity used in certain applications, such as an aerospace autoclave applications. In some embodiments, the disclosed additive manufacturing and thermal spray coating process enables the production of part 25, which in some embodiments may be one or more molds and/or tooling (FIG. 6A and FIG. 6B) with working surfaces composed of materials that may be too hard or tough to be used in other part fabrication processes. These materials include, but are not limited to, tungsten carbide, chrome carbide, and certain ceramic materials. Furthermore, the process can produce part 25 (FIG. 6A and FIG. 6B) with characteristics that are superior to parts made from a single material, leveraging the unique properties of the substrate and coating materials to achieve enhanced overall performance.

In some embodiments, the temperature of the thermal spray coating system 20 and the material selected for the part 15 are such that the temperature does not cause warping of the material of the part 15. This working surface enhancement may be performed in conjunction and/or combination with one or more additional working surface enhancement steps without deviating from the present disclosure.

In some embodiments, the part 15 is positioned on a platform 24 during the thermal spray coating process performed with thermal spray coating system 20. The platform 24 is configured to support and secure the part 15 in a desired orientation relative to the thermal spray apparatus. The platform 24 may include fixtures, clamps, or other devices to ensure that the part 15 remains stable and properly aligned throughout the coating process.

In some embodiments, the powder or wire material 21 used in the thermal spray process and configuration of thermal spray coating system 20 is selected based on the desired surface properties and performance characteristics of the final part 15. The material 21 may be a metal, ceramic, polymer, or composite, depending on the application. Examples of suitable materials include tungsten carbide, chrome carbide, stainless steel, aluminum, and titanium, among others.

In some embodiments, the gas stream 22 in the thermal spray coating system 20 is generated using a high-velocity oxygen fuel (HVOF) system, a plasma spray system, or an arc spray system, among others. The choice of thermal spray system depends on factors such as the material being deposited, the desired coating thickness and density, and the substrate material of the part 15.

In some embodiments, the thermal spray coating system 20 is performed in a controlled environment formed by thermal spray coating system 20, such as a spray booth or chamber, to ensure containment and ventilation as the process is performed. The environment may be equipped with exhaust systems, dust collectors, and air filtration units to manage the gases, fumes, and particulates generated during the coating process.

In some embodiments, the thermal spray process performed with thermal spray coating system 20 is monitored and controlled using sensors, cameras, and other instrumentation of thermal spray coating system 20 to ensure consistent and uniform coating deposition. These devices may be used to measure and adjust parameters such as the spray distance, angle, velocity, and temperature in real-time, enabling optimal coating quality and adherence.

In some embodiments, the thermal spray coating applied to the part 15 may undergo post-processing treatments, such as grinding, polishing, or heat treatment, to achieve the desired surface finish, hardness, or other properties. These post-processing steps are selected based on the specific requirements of the part application and the characteristics of the coating material.

In some embodiments, the thermal spray coating system 20 enables the creation of a part 15 with enhanced surface properties, such as increased wear resistance, corrosion resistance, thermal insulation, or release characteristics. These enhanced properties are beneficial for improving the performance, durability, and efficiency of the part 15 in its intended application, such as plastic injection molding, die casting, or composite manufacturing.

In some embodiments, the thermal spray coating system 20 creates a cohesive and continuous exterior surface on the part 15. The high-velocity impact of the molten particles onto the surface of the part 15 causes them to flatten, deform, and interlock with each other and with the substrate material. As the sprayed particles rapidly cool and solidify, they form a dense, adherent coating that covers the entire exterior surface of the part 15. This cohesive exterior surface layer provides a uniform and uninterrupted barrier that enhances the overall performance and functionality of the part 15.

In some embodiments, the cohesive nature of the thermal spray coating eliminates or minimizes the presence of voids, pores, or gaps between the individual spray particles and the substrate. This absence of discontinuities in the coating layer prevents the penetration of moisture, chemicals, or other harmful substances that could degrade the part 15 or affect the quality of the molded products. Additionally, the cohesive exterior surface created by the thermal spray coating system 20 provides a smooth, consistent interface for the molding or casting operations, ensuring the production of high-quality, dimensionally accurate components.

In some embodiments, the cohesive exterior surface created by the thermal spray coating process performed with thermal spray coating system 20 also imparts improved mechanical properties to the part 15. The dense, interconnected structure of the coating layer enhances the hardness, strength, and wear resistance of the part surface, enabling it to withstand the repeated stresses and abrasive forces encountered during the molding or casting cycles. This enhanced durability extends the service life of the part 15 and reduces the frequency of maintenance or replacement, ultimately leading to increased productivity and cost savings in the manufacturing process.

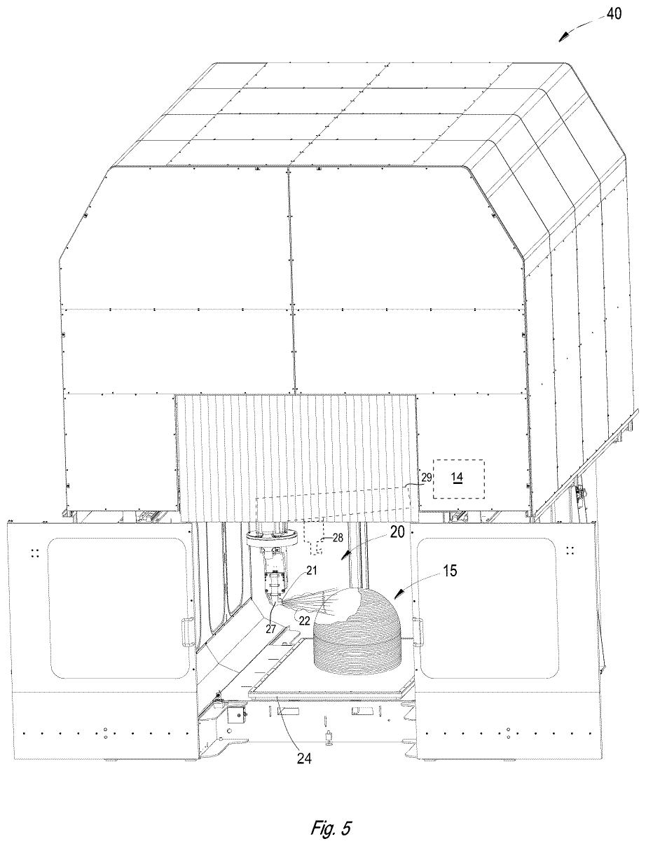

Referring to FIG. 5, in some embodiments, the thermal spray coating process is performed using a gantry-style computer numerical control (CNC) machine 40 incorporated as part of thermal spray coating system 20. The gantry-style CNC machine 40 is configured to automate and precisely control the movement and operation of the thermal spray apparatus, ensuring consistent and accurate application of the coating material onto the surface of the part 15.

In some embodiments, the gantry-style CNC machine 40 comprises a bridge-like structure (such as gantry 29) that spans over the platform 24 on which the part 15 is positioned. The bridge-like structure (such as gantry 29) supports a movable carriage that holds the thermal spray gun or nozzle, which is associated with material 21. The carriage is capable of translating along multiple axes, typically in the X, Y, and Z directions, enabling the spray gun and the associated material 21 to access and coat all surfaces of the part 15. In some embodiments, the carriage is also rotatable, such that the carriage operates in six degrees of freedom.

In some embodiments, the movement of the carriage and thermal spray gun and the material 21 is controlled by a computer-based system that executes a pre-programmed sequence of instructions. These instructions are derived from the CAD model of the part 15 and define the optimal path, speed, and orientation of the spray gun and the material 21 relative to the surface being coated. The computer-controlled motion ensures that the coating is applied evenly and with the desired thickness across the entire surface of the part 15.

In some embodiments, the thermal spray gun is fed with the coating material 21, such as powder or wire, from a storage hopper or spool mounted on the gantry-style CNC machine 40. The material 21 is conveyed to the spray gun via a feed system that controls the rate and consistency of the material delivery. The spray gun is also connected to a source of pressurized gas, such as compressed air, nitrogen, or a combustible fuel mixture, which is used to generate the high-velocity gas stream 22 that propels the molten coating particles onto the surface of the part 15.

In some embodiments, the gantry-style CNC machine 40 of thermal spray coating system 20 is equipped with sensors, cameras, and other monitoring devices that provide real-time feedback on the thermal spray coating process. These devices may measure parameters such as the temperature, velocity, and thickness of the deposited coating material 21, as well as the distance and angle of the spray gun relative to the surface being coated. The data collected by these sensors is used to make real-time adjustments to the process parameters, ensuring that the coating meets the desired specifications and quality standards.

In some embodiments, the use of a gantry-style CNC machine 40 for the thermal spray coating system 20 offers several advantages over manual or semi-automated methods. The CNC machine 40 provides greater precision, repeatability, and efficiency in the application of the coating, reducing the risk of human error or inconsistency. The automated process also enables faster production times, higher throughput, and reduced labor costs compared to manual coating methods. Furthermore, the gantry-style design of the CNC machine 40 allows for the coating of larger and more complex part geometries, expanding the range of applications for the thermal spray coating technology.

In some embodiments, as shown in FIG. 5, the gantry-style CNC machine 40 may incorporate a dual-head configuration, where both the thermal spray head 27 and the surface preparation head 28 are mounted on the gantry 29. The gantry 29 is configured to facilitate precise and coordinated movement of these heads across multiple axes, allowing for seamless transitioning between surface preparation and coating application on the part 15. The gantry 29 may be configured to support the heads 27, 28 in close proximity to each other, which may minimize the movement required for the transition between processes and reduces the overall processing time.

In some embodiments, the controller 14 is configured to coordinate the operation of the thermal spray head 27 and the surface preparation head 28. This coordination is configured such that surface preparation, such as oxide removal or surface roughening, is immediately followed by the thermal spray coating application, thereby preventing re-oxidation or contamination of the prepared surface. The controller 14 may include algorithms to determine the optimal path and sequence of operations for the heads 27, 28, based on the geometry and material properties of the part 15.

In some embodiments, the surface preparation head 28 may utilize techniques such as sandblasting, laser ablation, or other surface modification methods, as described herein. The head 28 is configured to be mounted on the gantry 29 such that it may be move to and/or positioned at various angles and distances relative to the part 15, enabling surface preparation of all surfaces of part 15.

In some embodiments, the thermal spray head 27 is configured to apply the coating material 21 through a high-velocity gas stream 22. The head 27 may be equipped with sensors that monitor the deposition process in real-time, providing feedback to the controller 14. Based on this feedback loop, the controller 14 may be configured to receive data from one or more sensor and to adjust the spray parameters, such as flow rate, spray angle, and standoff distance, based on the received data such that the coating is applied with a desired thickness and uniformity. For instance, the thermal spray head 27 can include infrared temperature sensors to monitor the temperature of the coating material 21 as it is being deposited, ensuring that the material is within the optimal temperature range for adhesion. Additionally, optical sensors may be integrated into the head 27 to measure the thickness of the deposited coating in real-time, providing feedback to the controller 14 for adjustments. In some embodiments, the surface heads 27, 28 may include sensors such as laser distance meters or ultrasonic sensors to measure the distance between the head and the part 15, Other sensors may include particulate sensors that detect the amount of material removed during processes like sandblasting, or spectroscopic sensors for analyzing the composition of the surface contaminants being ablated.

In some embodiments, the controller 14 may be configured to dynamically adjust the timing and sequencing of the heads 27, 28 based on sensor data. For example, if the sensors on the surface preparation head 28 detect incomplete oxide removal, the controller 14 can automatically reconfigure the path or parameters of the head 28 to revisit the area. Similarly, the controller 14 can adjust the operation of the thermal spray head 27 to compensate for any variations in the surface condition detected during the coating process.

In some embodiments, the controller 14 is configured to optimize the transition between surface preparation and coating application to minimize downtime and maintain the reactivity of the prepared surface. This optimization may involve synchronizing the movement of the gantry 29 with the operation of the heads 27, 28, ensuring that the surface preparation head 28 completes its task just as the thermal spray head 27 moves into position to apply the coating.

In some embodiments, a modular configuration of the gantry-style CNC machine 40 enables reconfiguration or upgrading of the heads 27, 28. This modularity is configured such that the system 20 may be adapted to different materials, part geometries, or coating requirements without the need for significant redesign. The controller 14 may include predefined settings for different head configurations, enabling quick changeovers and reducing setup time for new applications.

In some embodiments, the controller 14 is equipped with a user interface that is configured to receive one or more input and provide one or more user interface such that operators are enabled to interact with the thermal spray coating system 20. The interface may include a graphical touchscreen display that provides real-time visualizations of the coating process, including sensor readings, head positions, and process parameters. Operators can use the interface to input and adjust parameters, load CAD models, monitor the progress of the coating operation, and the like.

In some embodiments, the user interface is configured to facilitate the programming of the system 20. This programming may involve importing CAD models of the part 15, defining the desired coating paths, and setting process parameters such as spray rates, temperatures, and material flow rates. The interface may include tools for simulating the coating process, allowing operators to preview the operation and make adjustments before running the actual process. Additionally, the interface may offer remote access capabilities, enabling operators to monitor and control the system 20 from off-site locations.

Referring to FIG. 6A and FIG. 6B, in some embodiments, the final part 25 produced by the disclosed additive manufacturing and thermal spray coating process is shown. The part 25 features an enhanced outer surface that exhibits improved properties and performance compared to the uncoated substrate material.

In some embodiments, the enhanced outer surface of the part 25 is characterized by a smooth, uniform, and continuous coating layer that completely encapsulates the underlying substrate. The absence of visible pores, cracks, or delaminations in the coating layer demonstrates the cohesiveness and integrity of the surface enhancement achieved through the thermal spray process.

In some embodiments, the view of the part 25 in FIG. 6B illustrates the consistent thickness and adherence of the coating layer to the substrate material. The coating layer appears as a distinct, well-defined zone that seamlessly integrates with the surface of the part substrate, indicating strong bonding and mechanical interlocking between the coating and the base material.

In some embodiments, the enhanced outer surface of the part 25 exhibits superior hardness, wear resistance, and durability compared to the uncoated substrate. These improved properties are attributed to the coating material composition and the optimized thermal spray process parameters, which result in a dense, firmly adherent, and mechanically robust coating layer.

In some embodiments, the enhanced outer surface of the part 25 also provides enhanced thermal and chemical resistance, enabling the part to withstand the harsh operating conditions encountered in various molding and casting processes. The protective coating layer acts as a barrier against thermal degradation, corrosion, and chemical attack, extending the service life and maintaining the dimensional stability of the part 25.

In some embodiments, the enhanced outer surface of the part 25 facilitates improved release properties and reduced adhesion of the molded or cast material to the part surface. The smooth, low-friction nature of the coating layer minimizes surface defects, sticking, and residue buildup, ensuring consistent, high-quality production of molded or cast components.

In some embodiments, the part 25 with the enhanced outer surface produced by the disclosed additive manufacturing and thermal spray coating process represents a significant advancement over traditional part fabrication methods. The combination of additive manufacturing, which provides design flexibility, and thermal spray coating, which provides rapid production capabilities and surface enhancement benefits, results in part solutions that offer superior performance, durability, and cost-effectiveness compared to other manufacturing approaches.

In some embodiments, the part 25 includes internal layer lines 26. The layer lines 26 may be formed through the manufacturing processes, where successive layers of material are stacked to build the part 25. The specific arrangement and spacing of the layer lines 26 can be adjusted to optimize the mechanical properties, such as strength, durability, and thermal resistance, of the part. This configuration enables the part 25 to be tailored for specific applications and operational conditions, providing versatility and adaptability in its usage.

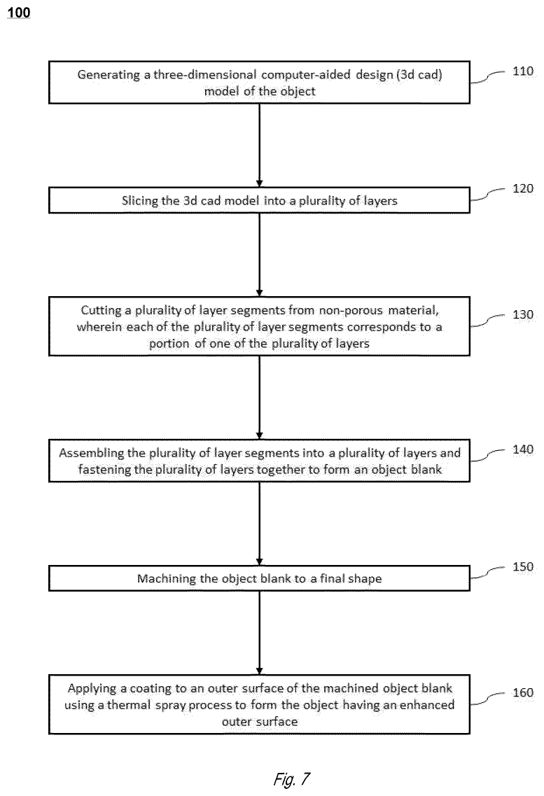

Referring to FIG. 7, in some embodiments, a method 100 of producing an object with an enhanced outer surface is disclosed. The method 100 combines additive manufacturing techniques, such as cut layer manufacturing, with thermal spray coating processes to create objects with desired surface properties and performance compared to objects produced using conventional manufacturing methods.

In some embodiments, the method 100 includes step 110, which involves generating a design data object, such as a three-dimensional computer-aided design (3D CAD) model or other electronic representation (e.g., an electronic model) of the object. The design data object is created using software that allows for the precise definition of the object's geometry, dimensions, and features. The design data object serves as the digital blueprint for the subsequent steps in the manufacturing process.

In some embodiments, once the design data object is generated, the method 100 includes step 120, where the design data object is sliced into a plurality of layers. This slicing process is performed using software that analyzes the design data object and divides it into a series of thin, parallel layers. Each layer represents a cross-sectional slice of the object at a specific height, and the thickness of each layer is determined based on the desired resolution and manufacturing parameters.

In some embodiments, after the slicing process, the method 100 includes step 130, which involves cutting a plurality of layer segments from non-porous material. Each layer segment corresponds to a portion of one of the plurality of layers defined in the previous step. The non-porous material used for cutting the layer segments is selected based on the desired properties of the final object, such as strength, durability, and thermal stability. Examples of suitable non-porous materials include metals, such as aluminum, steel, or titanium, and high-performance polymers.

In some embodiments, the cutting of the layer segments in step 130 is performed with a computer numerical control (CNC) machining center, such as machine 19 (FIG. 1), by programming provided to controller 14 and/or by manually interacting with controller 14 (e.g., via display 23) (FIG. 1). The machine 19 is programmed and/or configured with the geometry and cutting paths derived from the sliced design data object, ensuring precise and accurate fabrication of each layer segment. As the layer segments are cut, they are marked with identifying information if desired, such as the layer number or assembly order, to facilitate the subsequent assembly process. The marking may be performed by the machine 19r, or it may be performed manually by an operator.

In some embodiments, each layer of the object may be formed of multiple layer segments that are configured to abut one another within the layer. If desired, one or more layers are formed of a single segment (e.g., one continuous piece cut from material 18). This segmentation approach allows for the production of larger objects that may exceed the size limitations of the machine 19 used for cutting the layer segments. By dividing each layer into smaller segments, the method 100 enables the fabrication of objects with complex geometries and larger dimensions. The layer segments are configured to fit together seamlessly within each layer, ensuring that the assembled object blank accurately represents the original design data object.

In some embodiments, following the cutting of the layer segments, the method 100 includes step 140, which includes assembling the plurality of layer segments into a plurality of layers and fastening the layers together to form an object blank. The layer segments are stacked and aligned according to the assembly order determined in the step 130, ensuring that the object blank accurately represents the geometry of the original design data object. The layers are then fastened together using techniques such as adhesive bonding, mechanical fastening, or welding, depending on the material and size of the object blank.

In some embodiments, after the formation of the object blank, the method 100 continues with step 150, which includes machining the object blank to its final shape. This machining process is typically performed using another machine, such as a CNC machining center, which is programmed with the final geometry and dimensions of the object. The machining process removes any excess material and refines the surface of the object blank, bringing it into compliance with the original design data object. This step ensures that the object blank is precisely shaped and dimensioned, ready for the application of the surface coating.

In some embodiments, the final step of the method 100 is step 160, which involves applying a coating to the outer surface of the machined object blank using a thermal spray process. The thermal spray process is a versatile coating technology that can deposit a wide range of materials, including metals, ceramics, and polymers, onto the surface of the object blank. The specific coating material is selected based on the desired surface properties, such as hardness, wear resistance, corrosion resistance, or thermal insulation.

In some embodiments, the thermal spray process used in step 160 can include any one of the techniques discussed above. These processes involve heating the coating material to a molten or semi-molten state and propelling the material onto the surface of the object blank using a high-velocity gas stream. As the molten particles impact the surface, they flatten, cool, and solidify, forming a dense, adherent coating layer that enhances the surface properties of the object.

In some embodiments, the application of the thermal spray coating in step 160 results in an object with an enhanced outer surface that exhibits superior properties compared to the uncoated blank. The enhanced outer surface is typically characterized by improved hardness, wear resistance, corrosion resistance, and thermal stability, among other properties. These enhanced surface properties enable the object to perform better and last longer in demanding applications, such as molds, tools, and other high-wear components.

In some embodiments, the effectiveness of the thermal spray coating process applied to the object 25 (e.g., with head 27 and/or head 28) can be modified and/or enhanced through one or more modifications of the substrate surface prior to the application of the thermal spray coating. Surface preparation can be beneficial for a wide range of substrate materials, as it may remove impurities, oxides, or surface imperfections that could potentially interfere with coating adhesion. The nature and extent of surface preparation may depend on the specific substrate material, its surface condition, and the intended application of the coated object 25.

In some embodiments, surface preparation may be useful when the object 25 is composed of reactive metals or alloys that readily form surface oxides. For example, aluminum and its alloys are materials that, in some embodiments, benefit significantly from surface preparation. When aluminum, for example, is exposed to air, it may form a thin, protective layer of aluminum oxide on its surface. While this oxide layer provides corrosion resistance, it can potentially impede the adhesion of the thermal spray coating material 21 to the underlying aluminum substrate. Similar considerations may apply to other materials such as titanium, magnesium, or certain steels, or the like, which can also form surface oxides or other compounds that may affect coating adhesion.

In some embodiments, to achieve optimal adhesion of the thermal spray coating to the object 25, regardless of its material composition, surface layers that may impede adhesion may be removed immediately prior to the application of the coating material 21 with surface preparation head 28. This removal process can be integrated into the thermal spray coating system 20, allowing for a transition between surface preparation and coating application. The integration of surface preparation into the thermal spray coating process enables the creation of a clean, reactive surface that is primed for bonding with the coating material 21, which may resulting in a more durable and higher-performing coated object 25.

In some embodiments, one or more methods can be employed to remove surface layers or prepare the substrate surface of the object 25 for thermal spray coating. These methods may include mechanical techniques, chemical processes, and/or physical methods, each potentially offering distinct advantages for the substrate material and the particular requirements of the coating process.

In some embodiments, mechanical methods for surface preparation may include one or more techniques such as sandblasting, grit blasting, or shot peening. These processes can involve propelling abrasive particles at high velocity against the surface of the object 25, thereby removing surface oxides, contaminants, and creating a surface profile that can enhance coating adhesion, such as a roughened or smoothened surface profile. The abrasive media used in these processes may be selected based on the substrate material and the desired surface finish, and can include materials such as silicon carbide, steel shot, glass beads, or the like.

In some embodiments, chemical methods for surface preparation may be employed. These may include one or more processes such as acid etching, alkaline cleaning, solvent degreasing, or the like. Chemical methods can be particularly effective for removing oils, greases, and certain types of oxides from the surface of the object 25. The choice of chemical agent and the treatment parameters can be tailored to the specific substrate material and the nature of the surface contaminants to be removed.

In some embodiments, physical methods such as laser ablation may be used for surface preparation. Laser ablation can involve using a high-energy laser beam to vaporize surface contaminants and oxides from the object 25. This method can offer precise control over the area and depth of surface removal, and may be particularly suitable for objects with complex geometries or when minimal material removal is desired.

In some embodiments, the sandblasting process for surface preparation of the object 25 may utilize a compressed air system to propel abrasive particles through a nozzle at high velocity. The nozzle can be configured to provide a controlled and uniform distribution of the abrasive media across the surface of the object 25. The sandblasting parameters, including air pressure, nozzle distance, and blasting angle, may be adjustable and can be optimized based on the substrate material and the desired surface profile. The abrasive media used in the sandblasting process can be selected based on factors such as hardness, particle size, and shape, to achieve a desired balance between effective oxide removal and substrate damage.

In some embodiments, laser ablation for surface preparation of the object 25 may employ a laser system, which may be integrated into the gantry-style CNC machine 40. The laser system can be configured to emit short, high-energy pulses that vaporize surface contaminants and oxides without causing significant heating of the underlying substrate. The laser parameters, including wavelength, pulse duration, and energy density, may be adjustable and can be optimized for different substrate materials. The laser ablation process can be controlled by the controller 14, allowing for selective treatment of specific areas of the object 25 and enabling consistent surface preparation even for complex geometries.

In some embodiments, the surface preparation process can be integrated into the thermal spray coating system 20 to create a seamless manufacturing process (e.g., via the surface preparation head 28). This integration may involve modifications to the existing gantry-style CNC machine 40 to incorporate surface preparation capabilities alongside the thermal spray coating functionality.

In some embodiments, a dual-head configuration may be implemented on the gantry-style CNC machine 40. This configuration can involve mounting both the surface preparation head 28 and the thermal spray coating head 27 on the same gantry system 29. The surface preparation head 28 may be equipped with the necessary components for sandblasting, laser ablation, or other selected surface preparation methods. The thermal spray coating head 27 may retain its existing configuration for applying the coating material 21 using the gas stream 22.

In some embodiments, the dual-head configuration on the gantry-style CNC machine 40 may be arranged with the heads 27, 28 positioned adjacent to each other along the gantry 29 (e.g., mounted on a single gantry). This arrangement can allow for rapid switching between surface preparation and coating application without the need for tool changes. The controller 14 may be configured to coordinate the movement and operation of both heads 27, 28, based on desired timing and positioning for each process step.

In some embodiments, an exchangeable head system may be integrated into the gantry-style CNC machine 40. This system can allow for the exchange of the surface preparation head 28 and the thermal spray coating head 27 as desired during the manufacturing process. The head exchange mechanism may utilize a tool-changing system similar to those found in modern CNC machining centers, allowing for automated head swaps without manual intervention (e.g., performed entirely in response to commands generated with a controller of the thermal spray coating system 20).

In some embodiments, the process for switching between the surface preparation head 28 and the coating head 27 in an exchangeable head system may involve several steps. The gantry-style CNC machine 40 may first move to a designated tool-changing position. The current head (either surface preparation head 28 or coating head 27) may then be released and stored in a head storage area. The desired head (the other of surface preparation head 28 or coating head 27) can then be retrieved and securely attached to the machine. The controller 14 may verify the successful attachment of the new head before proceeding with the next process step.

In some embodiments, timing considerations for the surface preparation and coating application processes may be considered by the system and/or one or more component of the system, such as controller 14, based on one or more desired coating application. The controller 14 can be programmed to minimize the time interval between surface preparation and coating application, reducing the opportunity for re-oxidation or contamination of the prepared surface. This may involve coordinating the movement of the gantry-style CNC machine 40 to efficiently transition from surface preparation to coating application with minimal delay.

In some embodiments, sensors may be integrated into the surface preparation head 27 or other components of system 20 to monitor the quality and completeness of the surface preparation process in real-time. For a sandblasting process, these sensors may include optical sensors to detect changes in surface reflectivity, indicating the removal of surface oxides or contaminants. In the case of laser ablation, spectroscopic sensors may be employed to analyze the composition of the ablated material, providing feedback on the effectiveness of the oxide removal process.

In some embodiments, the controller 14 may be configured to receive and process data from these sensors, using this data to make real-time adjustments to the surface preparation process. For example, if sensors detect incomplete oxide removal in certain areas of the object 25, the controller 14 may automatically adjust parameters such as sandblasting pressure, laser power, or head movement speed to ensure thorough surface preparation across the entire object, such as by revisiting the area of incomplete oxide removal and/or adjusting timing parameters for the remainder of the oxide removal from the rest of the object 25.

In some embodiments, coordination between the surface preparation and coating application processes may be managed by the controller 14. This coordination can involve adjusting one or more timing control to minimize the interval between surface preparation and coating application, reducing the risk of surface recontamination. The controller 14 may also manage the movement of the gantry-style CNC machine 40 based on the transition between processes, potentially treating and coating sections of the object 25 sequentially to maintain the freshly prepared surface condition.

In some embodiments, the system 20 may incorporate adaptive control capabilities based on substrate conditions. The controller 14 may be programmed with algorithms that can analyze sensor data to identify variations in substrate material properties or surface conditions across different areas of the object 25. Based on this analysis, the controller 14 can dynamically adjust both surface preparation and coating parameters to optimize the process for each specific area of the object 25, such as by adjusting one or more parameters of the process as discussed herein based on the sensor data.

In some embodiments, the adaptive control system may utilize machine learning algorithms to continuously improve process parameters based on historical data and outcomes. The controller 14 may collect and analyze data from multiple coating operations, identifying patterns and correlations between process parameters and coating quality. This analysis can be used to refine and optimize the surface preparation and coating processes over time.

In some embodiments, the process control system may also include features for real-time quality assurance. Sensors mounted on the gantry-style CNC machine 40 may monitor the coating process, detecting issues such as overspray, insufficient coverage, or coating defects. The controller 14 can be programmed to respond to these issues in real-time, potentially adjusting spray parameters, initiating additional passes, or flagging areas for post-process inspection or rework, or the like. In some embodiments, the controller 14 is configured to initiate one or more automated responses to these issues and alter one or more system routine to implement one or more automated response.

In some embodiments, the integration of surface preparation into the thermal spray coating process can offer numerous benefits, enhancing the overall quality, performance, and efficiency of the manufacturing process for the object 25. These benefits may be realized through improved coating adhesion, enhanced coating performance and durability, and increased efficiency in the manufacturing process.

In some embodiments, improved coating adhesion can be a benefit of the integrated surface preparation process. By effectively removing surface oxides, contaminants, and creating an optimized surface profile immediately before coating application, the thermal spray coating material 21 may form stronger mechanical and chemical bonds with the substrate of the object 25. This enhanced adhesion can result in a more robust coating that is less prone to delamination or failure under stress or environmental exposure.

In some embodiments, the improved adhesion achieved through integrated surface preparation can lead to enhanced coating performance and durability. The stronger bond between the coating and the substrate may allow the coated object 25 to better withstand thermal cycling, mechanical stresses, and corrosive environments. This can potentially extend the service life of the object 25 and improve its reliability in demanding applications.

In some embodiments, the enhanced coating performance may also manifest as improved functional properties of the coated surface. Depending on the specific coating material 21 and application, these improvements may include better wear resistance, increased corrosion protection, enhanced thermal insulation, or improved electrical conductivity. The optimized surface preparation can allow these functional properties to be more fully realized by ensuring intimate contact between the coating and the substrate.

In some embodiments, the integration of surface preparation into the thermal spray coating system 20 can lead to increased efficiency in the manufacturing process. By combining surface preparation and coating application in a single, automated system, the overall production time for the object 25 may be reduced. This integration can eliminate the need for separate surface preparation equipment and can minimize handling and transportation of the object 25 between process steps, potentially reducing the risk of surface recontamination.

In some embodiments, the automated nature of the integrated system, controlled by the controller 14, can lead to improved process consistency and repeatability. This can result in more uniform coating quality across multiple objects, potentially reducing rejection rates and improving overall product quality. The ability to precisely control and replicate the surface preparation and coating processes can be particularly beneficial in industries with stringent quality control requirements, such as aerospace or medical device manufacturing.

In some embodiments, the integrated system's ability to adapt to different substrate materials and geometries can offer flexibility in manufacturing. The same system may be used to process a variety of objects 25 with different shapes, sizes, and material compositions, potentially reducing the need for multiple specialized coating systems and increasing overall equipment utilization.

In some embodiments, the integration of surface preparation into the thermal spray coating process can offer numerous benefits, enhancing the overall quality, performance, and efficiency of the manufacturing process for the object 25. By effectively removing surface oxides, contaminants, and creating an optimized surface profile immediately before coating application, the thermal spray coating material 21 may form stronger mechanical and chemical bonds with the substrate of the object 25. This enhanced adhesion can result in a more robust coating that is less prone to delamination or failure under stress or environmental exposure. The improved bond between the coating and the substrate may allow the coated object 25 to better withstand thermal cycling, mechanical stresses, and corrosive environments, potentially extending its service life and improving reliability in demanding applications.

In some embodiments, while the integrated surface preparation and thermal spray coating process has been described primarily in the context of aluminum substrates, it can be applied to a wide range of substrate materials. The system may be configured to handle various metals, alloys, ceramics, or even certain polymers, with the surface preparation parameters and coating materials adjustable to suit each specific substrate. For instance, the process may be adapted for materials such as titanium, stainless steel, copper alloys, or composite materials, or the like, each potentially requiring unique surface preparation techniques and coating parameters to achieve optimal results.

In some embodiments, alternative surface preparation techniques may be incorporated into the integrated system. These could include plasma cleaning, which uses ionized gas to remove surface contaminants; ultrasonic cleaning, which can be effective for removing particulate matter and oils; or chemical etching processes tailored to specific substrate materials, or the like. The gantry-style CNC machine 40 may be configured with modular components, allowing for the integration of these alternative surface preparation methods as needed for different applications or advancements in surface preparation technology.

In some embodiments, the integrated surface preparation and thermal spray coating system may incorporate advanced automation and artificial intelligence (AI) capabilities for process optimization. Machine learning algorithms may be employed to analyze prior process data, identifying complex relationships between surface preparation parameters, coating parameters, and final coating quality. This Al-driven approach could enable continuous process improvement, with the system autonomously adjusting parameters to optimize coating performance for each specific object 25. Additionally, predictive maintenance capabilities could be integrated, allowing the system to anticipate and schedule maintenance activities, minimizing downtime and ensuring consistent coating quality over extended production runs.

In some embodiments, the method 100 described in FIG. 7 offers several advantages over other manufacturing processes. By combining the design flexibility and rapid production capabilities of additive manufacturing with the surface enhancement benefits of thermal spray coating, the method 100 enables the creation of objects with complex geometries and superior surface properties in a faster and more cost-effective manner compared to traditional manufacturing techniques. This approach facilitates production of high-performance objects in numerous industries, including automotive, aerospace, consumer products, and medical devices.

From the foregoing detailed description, it will be evident that there are a number of changes, adaptations and modifications of the present disclosure which come within the province of those persons having ordinary skill in the art to which the aforementioned disclosure pertains. However, it is intended that all such variations not departing from the spirit of the disclosure be considered as within the scope thereof as limited by the appended claims.

1. A method of producing an object, the method comprising:
receiving a three-dimensional computer-aided design (3D CAD) model of the object;
cutting a plurality of layer segments from at least one sheet of a non-porous material using the 3D CAD model, wherein each of the plurality of layer segments corresponds to at least a portion of the 3D CAD model;
assembling the plurality of layer segments into a plurality of layers and fastening the plurality of layers together to form a blank of the object being produced;
machining a first outer surface of the blank of the object being produced to form a final shape, wherein the first outer surface is entirely formed from the non-porous material;
preparing the first outer surface of the machined blank of the object being produced, after the object has been assembled from the plurality of layer segments, using a surface preparation process that includes propelling particles against the first outer surface after the first outer surface has been machined; and
applying a coating formed from a powder to the machined and prepared first outer surface of the blank of the object being produced, using a thermal spray process that includes melting the powder, such that the coating adheres to the prepared and machined first outer surface to form a second outer surface of the object conforming to the final shape.

2. The method of claim 1, further comprising marking an assembly order or assembly position on each of the plurality of layer segments prior to assembling the plurality of layer segments into the plurality of layers and fastening the plurality of layers together to form the blank.

3. The method of claim 1, wherein the cutting is performed using a computer numerical control (CNC) machining center.

4. The method of claim 1, wherein the machining is performed using a computer numerical control (CNC) machining center.

5. The method of claim 1, wherein the non-porous material is selected from the group consisting of aluminum, steel, and titanium.

6. The method of claim 1, wherein the coating comprises a material selected from the group consisting of alloys, tungsten carbide, chrome carbide, stainless steel, zinc, aluminum, tin, copper, nickel, cobalt, cermets, ceramics, and polymers.

7. The method of claim 1, wherein the thermal spray process is selected from the group consisting of high velocity air fuel (HVAF) spray, high velocity oxygen fuel (HVOF) spray, spray and fuse, plasma spray, and flame spray.

8. The method of claim 1, wherein the object is a mold or a tool.

9. The method of claim 1, wherein the second outer surface is a continuous, cohesive surface.

10. A method of producing an object, the method comprising:
receiving a three-dimensional computer-aided design (3D CAD) model;
forming an article of the object being produced, the article comprising a plurality of layer segments that are assembled and secured together, each of the plurality of layer segments having been cut from a non-porous material according to the 3D CAD model, and each of the plurality of layer segments corresponding to a portion of the 3D CAD model;
machining the article of the object being produced to a final shape using a first computer numerical control (CNC) machine, wherein an outer surface of the final shape of the machined article is formed entirely from the non-porous material;
preparing the outer surface of the machined article of the object being produced, after the object has been assembled from the plurality of layer segments, using a surface preparation head supported by a gantry of a second CNC machine to perform a surface preparation process that includes (i) alkaline cleaning of the outer surface, (ii) propelling glass beads against the outer surface, and (iii) applying laser ablation to the outer surface, after the outer surface has been machined; and
applying a coating formed from a powder to the machined and prepared outer surface of the final shape of the machined article of the object being produced, using a thermal spray coating head of the gantry to perform a thermal spray process that includes melting the powder, wherein the surface preparation head is positioned adjacent to the thermal spray coating head on the gantry.

11. The method of claim 10, wherein the non-porous material is selected from the group consisting of aluminum, steel, and titanium.

12. The method of claim 10, wherein the coating comprises a material selected from the group consisting of alloys, tungsten carbide, chrome carbide, stainless steel, zinc, aluminum, tin, copper, nickel, cobalt, cermets, ceramics, and polymers.

13. The method of claim 10, wherein the thermal spray process is selected from the group consisting of high velocity air fuel (HVAF) spray, high velocity oxygen fuel (HVOF) spray, spray and fuse, plasma spray, and flame spray.

14. The method of claim 10, wherein the second CNC machine is configured to move the thermal spray coating head along at least three axes relative to the machined article during the applying the coating formed from the powder to the outer surface of the machined article using the thermal spray process.

15. The method of claim 10, further comprising: controlling, using a controller, the second CNC machine to apply the coating to the outer surface of the machined article according to a predetermined pattern based on the 3D CAD model of the object.

16. The method of claim 10, wherein the object is selected from the group consisting of a mold and a tool.

17. A method of producing an object, the method comprising:
receiving a three-dimensional computer-aided design (3D CAD) model of the object;
slicing the 3D CAD model into a plurality of 3D CAD layers;
cutting a plurality of layer segments from a sheet of non-porous material according to the 3D CAD model, wherein each layer segment corresponds to at least a portion of one of the plurality of 3D CAD layers;
assembling the plurality of layer segments into a plurality of layers and fastening the plurality of layers together to form a blank;
machining the blank to a final shape;
preparing an outer surface of the machined blank assembled from the plurality of layer segments using a surface preparation process that includes propelling particles against the outer surface after the outer surface has been machined, wherein the entire outer surface of the machined blank is formed from the non-porous material; and
applying a coating formed from a powder to the machined and prepared outer surface of the machined blank using a thermal spray process that includes melting the powder to form an outer surface of the object,
wherein the surface preparation process and the thermal spray process are performed by an integrated system comprising a CNC machine configured with at least one of:
(i) a dual-head configuration including a surface preparation head, and a thermal spray coating head supported by a gantry, or
(ii) an exchangeable head system allowing for switching between a surface preparation head and a thermal spray coating head supported by a gantry.

18. The method of claim 17, wherein the surface preparation process comprises at least one of sandblasting, grit blasting, laser ablation, chemical etching, or plasma cleaning.

19. The method of claim 17, wherein the non-porous sheet of material is formed of aluminum or an aluminum alloy, and wherein the surface preparation process comprises removing an aluminum oxide layer from the outer surface of the machined blank immediately prior to applying the coating.

20. The method of claim 17, wherein the CNC machine is programmed to perform the surface preparation process and the thermal spray process sequentially on sections of the object.
